(19) United States
(12) Patent Application Publication
(10) Pub. No.: US 2025/0093198 A1
(43) Pub. Date: Mar. 20, 2025

(54) SYSTEM, METHOD, AND APPARATUS FOR EXTENDED FIELD DIGITAL HOLOGRAPHIC VIBRATION IMAGING VIA ALIASED SPARSE SPATIAL SAMPLING

(71) Applicant: Exciting Technology LLC, Dayton, OH (US)

(72) Inventor: Matthew P. Dierking, Springfield, OH (US)

(21) Appl. No.: 18/889,085

(22) Filed: Sep. 18, 2024

Related U.S. Application Data
(60) Provisional application No. 63/539,018, filed on Sep. 18, 2023.

(51) Int. Cl. G01H 9/00; G01B 11/16; G03H 1/02; G03H 1/16; G03H 1/22

(52) U.S. Cl. CPC G01H 9/00; G01B 11/164; G03H 1/02; G03H 1/2202; G03H 2001/0212; G03H 2001/0216; G03H 1/16; G03H 2001/2231; G03H 2222/12; G03H 2222/33; G03H 2223/16; G03H 2223/23; G03H 2223/24

(57) ABSTRACT

A device may include a stable laser light source configured to provide a master reference in a Doppler vibrometer scheme, a camera configured to receive scattered light from an object and a reference beam, an optical device configured to generate multiple illumination beams, an acquisition system configured to acquire images and precision timing data returned from the object, and an image processor configured to demodulate light detected by the camera via digital holographic scheme. The example image processor performs pulse-pair Doppler processing to determine vibration of the object.

### CROSS REFERENCE TO RELATED APPLICATIONS

The present application claims the benefit of U.S. Provisional Patent Application No. 63/539,018, entitled “SYSTEM, METHOD, AND APPARATUS FOR EXTENDED DIGITAL HOLOGRAPHIC VIBRATION IMAGING VIA ALIASED SPARSE SPATIAL SAMPLING”, filed on 18 Sep. 2023.

The foregoing application is incorporated herein by reference in the entirety for all purposes.

### BACKGROUND

Previously known vibrometry imaging systems suffer from a number of drawbacks. Limited measurement spatial field and bandwidth are present in such systems, for example, due to camera frame rate limitations, camera detector size or other system components that limit the sampling rate or accuracy. Some previously known systems have small target fields limited by the speckle size, accepting the consequent resolution, efficiency and/or detection capability limits. Some previously known systems utilize uniform spatial sampling, accepting the consequent measurement bandwidth, and/or detection capability limits. Limited measurement bandwidth present in imaging systems reduces the effective vibration measurement bandwidth, effective resolution, system power, system efficiency and imaging target size available for the system, thereby limiting the applications and performance outcomes for such systems. Some systems employ special purpose focal planes which introduce significant cost and complexity in hardware configurations, and require additional processing and synchronization.

### SUMMARY

Embodiments herein provide for extended spatial field digital holographic image measurement with high speed temporal acquisition. The approach combines spatially sparse illumination to generate bandlimited aliased fringes with sparse acquisition and processing to enable a wide field digital holographic vibration imaging system. Embodiments provide reduced hardware cost and complexity for systems, while providing improved performance, including performance aspects such as expanded target size, higher temporal sampling, increased spatial resolution, reduced system power, increased measurement efficiency. Example aspects of embodiments herein include sparse spatial digital holographic measurement methods using general purpose cameras, controlled spatial aliasing, sparse pulsed Doppler processing and vibration image formation methods. Spatially sparse illumination provides the use sparse processing to greatly enhance performance and reduce costs as well as avoid aliasing of spatial modal structures. Randomly distributed spatio-temporal sampling of frames allows for spatial and temporal measurement bandwidths beyond the typical Nyquist limit and enhanced spectral.

In some aspects, the techniques described herein relate to a vibration image measurement system including: a stable laser light source configured to provide a master reference in a Doppler vibrometer scheme; a camera configured to receive scattered light from an object and a reference beam; an optical device configured to generate multiple illumination beams; an acquisition system configured to acquire images and precision timing data returned from the object; an image processor configured to demodulate light detected by the camera via digital holographic scheme; an image processor configured to perform pulse-pair Doppler processing to determine vibration of the object; first optics configured to direct light from the stable laser light source to provide sparse illumination of the object; second optics configured to provide the reference beam for the camera; relay optics configured to provide required image locations of the sparse illumination spots; and third optics configured to mix the received light with the spatially offset reference beam for holographic detection.

In some aspects, the techniques described herein relate to a vibration measurement system, further including fixed plates configured to create uniformly spaced sparse illumination spots in an extended target measurement field.

In some aspects, the techniques described herein relate to a vibration measurement system, further including fixed plates configured to create randomly spaced sparse illumination spot in an extended target measurement field.

In some aspects, the techniques described herein relate to a vibration measurement system, further including a programmable phase plate configured to create arbitrarily spaced sparse illumination spots in an extended target measurement field.

In some aspects, the techniques described herein relate to a vibration measurement system, further including wherein an amplitude of transmitted spots is modulated to provide uniform detection across an extended target measurement field.

In some aspects, the techniques described herein relate to a vibration measurement system, wherein the image processor is further configured to create complex images containing the amplitude and phase for each image location utilizing digital holographic detection and demodulation.

In some aspects, the techniques described herein relate to a vibration measurement system, wherein the image process is further configured to create the complex images for each image location from an extended target field.

In some aspects, the techniques described herein relate to a vibration measurement system, wherein the image processor is further configured to create complex images for each image location from an extended target field utilizing digital holographic detection and demodulation.

In some aspects, the techniques described herein relate to a vibration measurement system, wherein the image processor is further configured to create complex images containing the amplitude and phase for each image location from an extended target field utilizing digital holographic detection and demodulation, and aliased bandlimited signals.

In some aspects, the techniques described herein relate to a vibration measurement system, wherein the image processor is further configured to create complex images containing the amplitude and phase for each image location from an extended target field utilizing digital holographic detection and demodulation, and sparse aliased bandlimited signals to create high spatial resolution complex images.

In some aspects, the techniques described herein relate to a vibration measurement system, wherein the image processor is further configured to develop spectral products at a maximum frame rate utilizing temporal pulse-pair Doppler processing with uniform temporal sampling.

In some aspects, the techniques described herein relate to a vibration measurement system, wherein the image processor is further configured to develop spectral products utilizing combined spatial and temporal sparse processing.

In some aspects, the techniques described herein relate to a vibration measurement system, wherein the image processor is further configured to apply sparse temporal pulse-pair processing having a temporal precision equal to a temporal integration time.

In some aspects, the techniques described herein relate to a vibration measurement system, wherein the image processor is further configured to apply the sparse temporal pulse-pair processing at a maximum frame rate.

In some aspects, the techniques described herein relate to a vibration measurement system, wherein the image processor is further configured to perform holographic imaging to extract a complex image with amplitude and phase.

In some aspects, the techniques described herein relate to a vibration measurement system, wherein the image processor is further configured to perform sparse digital holographic image formation of extended target fields from aliased, bandlimited randomly spaced samples.

In some aspects, the techniques described herein relate to a vibration measurement system, wherein the image processor is further configured to perform sparse digital holographic image formation of extended target fields from aliased, bandlimited uniformly spaced samples.

In some aspects, the techniques described herein relate to a vibration measurement system, wherein the image processor is further configured to perform sparse pulse-pair Doppler processing to extract a phase signal from each location within a complex data volume.

In some aspects, the techniques described herein relate to a vibration measurement system, wherein the holographic detection is performed in an image plane of the camera.

In some aspects, the techniques described herein relate to a vibration measurement system, wherein at least one of the optical device or the stable laser light source includes an amplified illumination laser.

In some aspects, the techniques described herein relate to a vibration measurement system, wherein the image processor is further configured to measure and correct systematic phase perturbations.

In some aspects, the techniques described herein relate to a vibration measurement system, wherein at least one of the optical device or the stable laser light source includes a pulsed illumination laser.

In some aspects, the techniques described herein relate to a vibration measurement system, wherein the camera is further configured to provide precision timing holographic detection in an image plane of the camera.

### BRIEF DESCRIPTION OF THE FIGURES

FIG. 1 depicts a previously known system for an imaging vibrometer.

FIG. 2 depicts an example holographic detection process.

FIG. 3 depicts a previously known speck limited illumination and extended target illumination area.

FIG. 4 depicts example fringes for a single point target and a diffuse target each with 1×, 2×, 4×, and 8× detector.

FIG. 5 depicts an example detector spatial modulation transfer function.

FIG. 6 depicts an example sinusoidal vibration modal pattern with 1×, 2×, 4×, and 8× detector footprints illustrating spatial mode averaging at the target.

FIG. 7 Depicts an example aliased digital holographic vibration imaging (DHVI) with sparse spatial illumination, acquisition and processing, of the present disclosure.

FIG. 8 depicts example un-aliased sample locations (filled circles), which are the same in the image and extended target spaces, and aliased locations from the extended target areas (gray and black circles), which are aliased into the image field providing samples over the extended target area encoded into the image.

FIG. 9 depicts an example detector modulation transfer function (MTF), Nyquist cutoff, and uniform sparse sampling according to embodiments of the present disclosure.

FIG. 10 depicts an example detector MTF, Nyquist cutoff, and random sparse sampling according to embodiments of the present disclosure.

FIG. 11 depicts an example baseline and extended illumination according to embodiments of the present disclosure.

FIG. 12 depicts an example extended illumination field according to embodiments of the present disclosure.

FIG. 13 depicts an example sparse aliased signal remapped into the extended field according to embodiments of the present disclosure.

FIG. 14 depicts an example uniform sparse digital holographic velocity image processing according to embodiments of the present disclosure.

FIG. 15 depicts an example pulse-pair processing and uniform DHVI sampling according to embodiments of the present disclosure.

### DETAILED DESCRIPTION

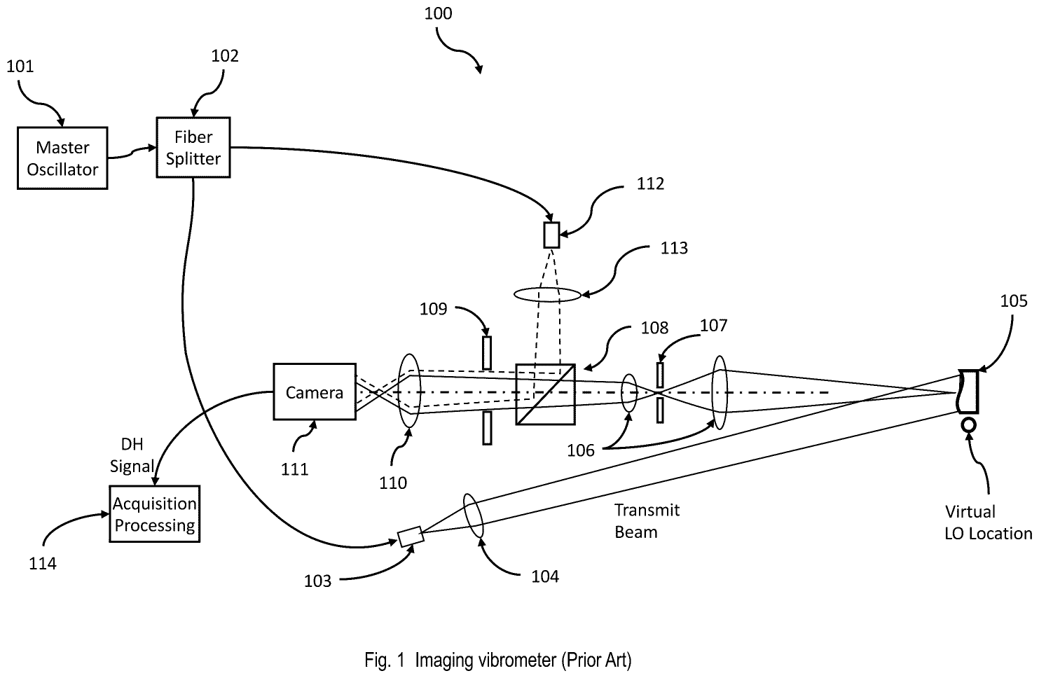

Referencing FIG. 1, an example previously known system for performing vibration imaging based on holographic detection is depicted. The example system includes a master oscillator 101, and a fiber splitter 102 that divides the master oscillator beam into an imaging beam (emitted from fiber terminator 103) and a local oscillator beam (emitted from fiber terminator 112). The imaging beam is transmitted to the target 105 through collimating optics 104. The reflected field is collected and scaled by a telescope 106 and the field stop 107 internal to the telescope limits the size of the target field. The reflected field is combined at mixer 108 with the spatially offset local oscillator collimated by a lens 113. A pupil stop 109 limits the size of the mixed pupil field and a relay lens images the pupil field onto the camera 111 producing the real part of the holographic interferogram. In the example system, the camera runs at a specified frame rate and produces multiple frames of holographic data which is collected by the acquisition and processing system.

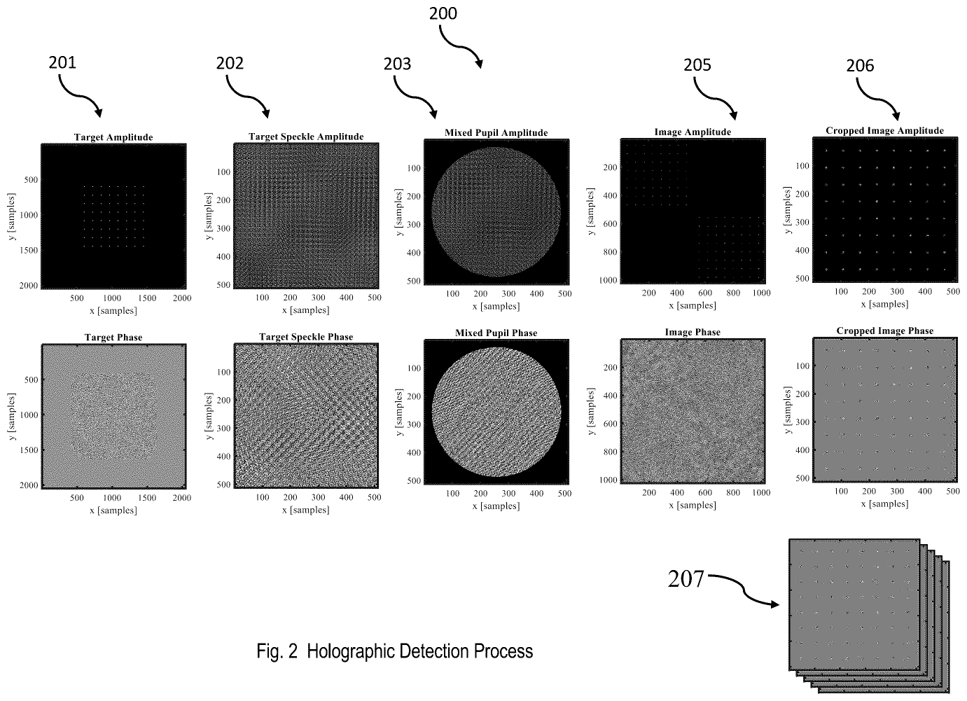

Referencing FIG. 2, an example of the holographic data detection process 200 based on the example system 100 begins with the illuminated target 105 which has reflectivity and phase associated with surface roughness resulting in 201. The example of FIG. 2 depicts an amplitude of each image in the top row, and a phase of each image in the bottom row. The reflected field at the mixer 202 is cropped to the desired aperture size 203 and mixed with the local oscillator producing a mixed field. The relay lens 110 images and scales the mixed pupil onto the camera focal plane where real part of the hologram of the target is detected. The complex image is calculated by taking the two dimension Fourier transform of pupil resulting complex image pairs located in opposite quadrants 205 due to the modulation of the spatially offset local oscillator. Cropping out a single quadrant produces a complex image 206 which carries a phase at each image point that is proportional to the instantaneous range to target. For a vibrating target, the phase associated with each pixel changes over time. To measure the vibration, the holographic measurements are repeated over time to generate a stack of complex images 207 representing the spatially resolved temporal phase history data (PHD) of the target.

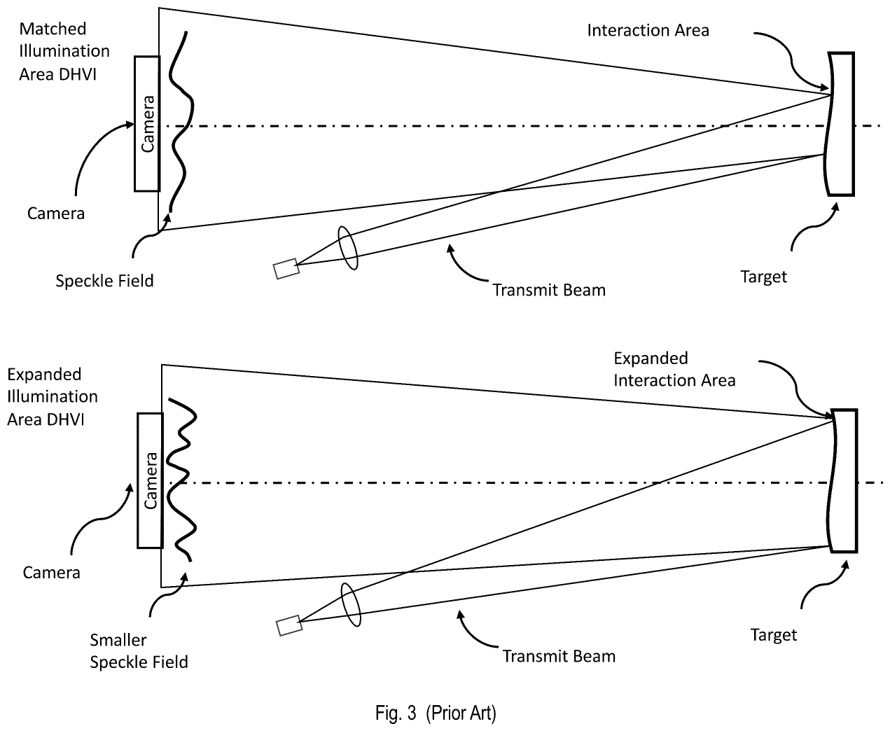

The spatial extent of the target field is limited by the speckle size. For a field reflected from a diffuse object, the approximate speckle size, Dₛₚ, is

$${D}_{s p} = \frac{λ}{{L}_{T}} {R}_{T} \qquad ( 1 )$$

where λ is the operating wavelength, R_{T} is the range to the target and D_{T} is the diameter of the illuminated area on the target. Referencing FIG. 3, the speckle size decreases as the target size increases and the range to target decreases. Combined with the size of the camera pixel, this limits the size of the target field. A relay optical system imaging the pupil onto the focal plane provide magnification, M_{R}, such that the speckle size at the focal plane is

$$2 {D}_{D} = {M}_{R} \frac{λ}{{L}_{T}} {R}_{T} \qquad ( 2 )$$

is scaled to Nyquist sample the interferogram with 2 samples per speckle, i.e., twice the detector size, D_{D}, is

$${D}_{D} = {M}_{R} \frac{λ}{2 {L}_{T}} {R}_{T} \qquad ( 3 )$$

And the relay magnification required to properly sample the fringe pattern is

$${M}_{R} = \frac{2 {L}_{T} {D}_{D}}{λ {R}_{T}} \qquad ( 4 )$$

The fringe size and sampling levy constraints on the link budget by limiting the effective aperture. When M_{R} is set to generate the required speckle size and camera with active dimension N_{c}×N_{c}, the size of aperture at the pupil is

$${D}_{A P} = \frac{{N}_{D} {D}_{D}}{{M}_{R}} = {N}_{D} \frac{λ {R}_{T}}{2 {L}_{T}} \qquad ( 5 )$$

Since there is only magnification between the speckle size in the pupil and on the FPA, the aperture size at the pupil is the half the size of a speckle times the number of detectors. For short range and large targets, the useful aperture is small. For example, a system operating with λ=1.5 um, R_{T}=3m and L_{T}=0.25 m the aperture is just D_{AP}=960 um. This small aperture impacts the link budget as well as target support and resolution.

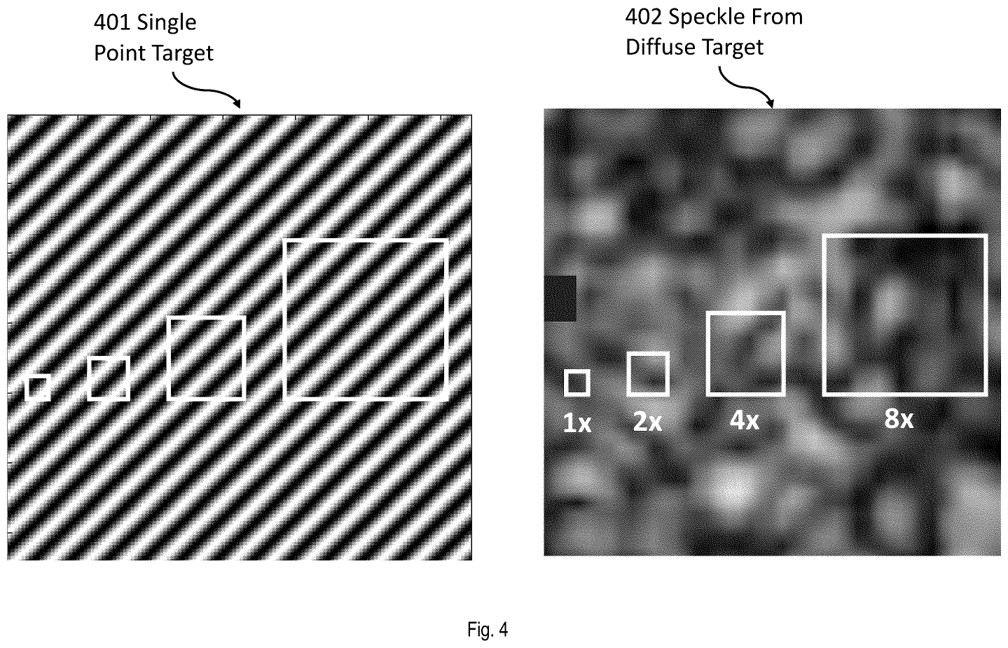

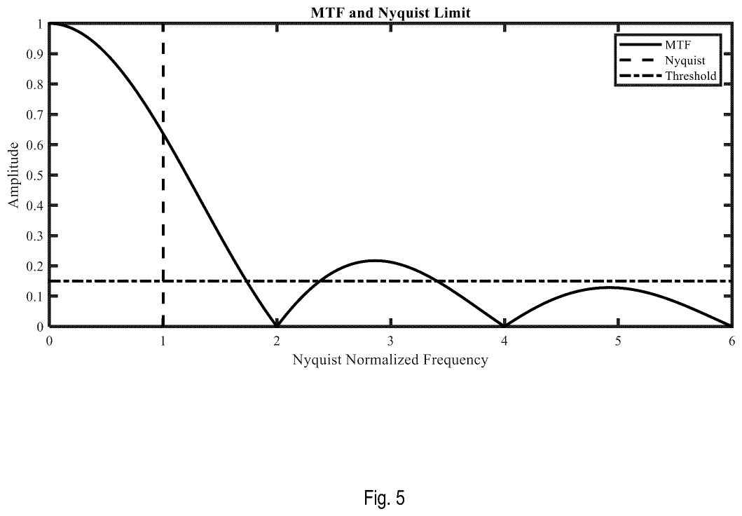

Each camera pixel has finite spatial extent and is not an ideal interferogram sampler. The detector does not sample a fringe at a point, but rather integrates a portion of the fringe over the detector area. FIG. 4 shows the fringes for a single point target 401 and a diffuse target 402 each with 1×, 2×, 4×, and 8× detector sizes overlaid on top. These illustrate the increasing fringe averaging that occurs with increasing detector size. This is effectively a low pass spatial filter with a modulation transfer function (MTF) which can have a significant impact on fringe measurements. For a detector of width x_{d} the MTF H_{d}(f) is

$${H}_{d} ( f ) = \frac{sin π {x}_{d} f}{π {x}_{d} f} \qquad ( 6 )$$

where f is the spatial frequency and x_{d} (FIG. 5). This sinc function has a first zero is at f=1/x_{d}. This shows that for high fill detectors, the MTF increasing attenuates frequencies as they approach the Nyquist frequency.

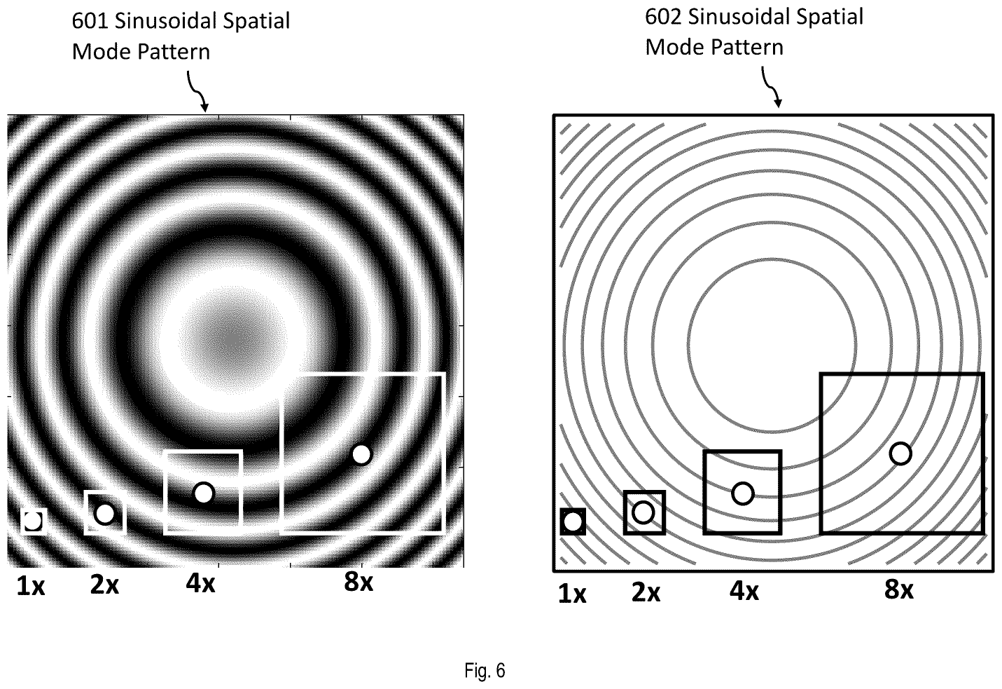

Referencing FIG. 6, vibration spatial mode averaging can occur at target for large effective detector sizes. Increasing the spatial coverage on the target while keeping the same number of resolution cells can introduce spatial mode averaging at the target. FIG. 6 shows an example vibration sinusoidal mode pattern with 1×, 2×, 4×, and 8× detector areas, respectively. The 1× detector Nyquist samples the fringes but increasing fringe averaging would clearly be present, for example comparing 601 and 602. The 2×, 4×, and 8× detectors show increasing levels of mode averaging which would produce erroneous phase estimates for the locations as shown.

Sparse spatio-temporal sampling and processing are used to extend the target field exploiting bandlimited aliased coherent images. Digital holographic vibration imaging is an interferometric process exploiting the speckle field created by the illumination beam reflected from an optically rough target. Physical properties including the speckle size, target spatial sampling relative to the vibrational spatial modes and the temporal speckle evolution drive multiple spatio-temporal constraints on the system including field size and effective resolution. A key constraint is that the speckle pattern must be effectively Nyquist sampled in both domains. In digital holography, cameras are used for detection, and in real cameras the pixel size limits the spatial sampling and the frame rate and integration time limit the temporal sampling. The detector size impacts the sampling in two ways. First, the size of the size detector effectively sets the spatial Nyquist rate. Second, the extent of the detector in a non-ideal sampler effectively averages the signal over the detector area. The detector spatial sampling modulation transfer function (MTF) is effectively a low pass filtered integrator rather than the ideal delta function. Similarly, the temporal sampling is limited by integration time and frame rate. The effective integration time is a low pass integrator with a temporal MTF that limits the fastest temporal variation which can be measured, i.e., the shortest duration fringe pattern that can be frozen by the measurement. The frame rate establishes the temporal Nyquist rate for the system.

Finally, each camera frame produces a large amount of digital data which must be transferred from the camera. The minimum readout time dictates the maximum camera frame rate. In general, the frame rate goes down as the number of pixels per frame goes up, which levies a final space-time coupled constraint on a system.

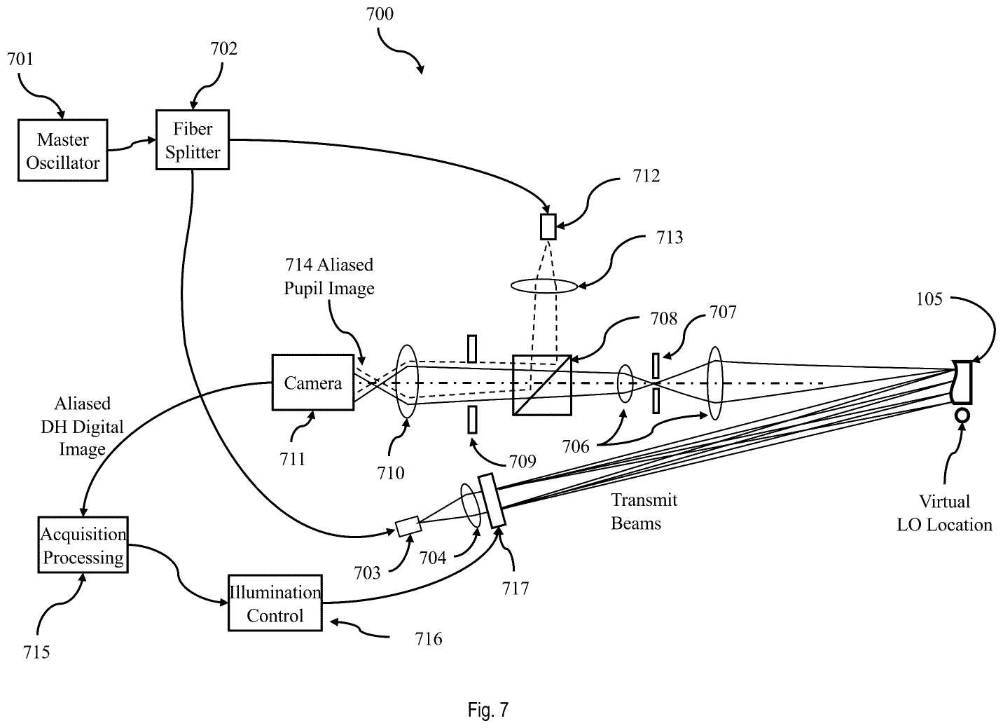

The spatially sparse DHVI system exploits methods which can overcome these limits under specific measurement conditions disclosed herein. Referencing FIG. 7, an embodiment 700 of the present disclosure for performing extended field vibration imaging based on holographic detection is depicted. The example system includes a master oscillator 701, which may be a stable laser light source, and a fiber splitter 702 that divides the master oscillator beam into an imaging beam (emitted from fiber terminator 703) and a local oscillator beam (emitted from fiber terminator 712). The imaging beam is transmitted to the target 105 through focusing optics 704. The reflected field is collected and scaled by a telescope 706 and the field stop 707 internal to the telescope limits the size of the target field. The reflected field is combined at mixer 708 with the spatially offset local oscillator collimated by a lens 713. A pupil stop 709 limits the size of the mixed pupil field and a relay lens 710 images the pupil field onto the camera 711 producing the real part of the holographic interferogram. In the example system, the camera runs at a specified frame rate and produces multiple frames of holographic data which is collected by the acquisition and processing system. In certain embodiments, a fixed phase grating 717 (e.g., using fixed plates) modulates the transmit beam to produce multiple uniformly spaced, sparse illumination spots on the target to provide wide field but spatially bandlimited illumination patterns. In another embodiment, the phase grating 717 is fixed and produces a spatially sparse, randomly distributed illumination pattern spread across an extended field. In a further embodiment, the Acquisition and Processing element 715 provides arbitrary grating descriptions to an Illumination Control 716 to drive an active phase modulator such as a liquid crystal phase modulated to provide dynamically defined sparse illumination patterns across the extended field. The grating 717, acquisition and processing element 715, and illumination control 716 may be embodied, in whole or part, using any dynamic and/or actively controlled grating assembly, and the example embodiments are non-limiting. The system of FIG. 7 creates an aliased pupil image 714 utilized for operations herein. Operations herein using an image processor may be embodied, in whole or part and without limitation, in the acquisition processing 715 component, on a controller and/or processor positioned in the camera 711.

In high speed, wide field digital holographic (DH) imaging, the speckle size at the aperture decreases as the target area grows. In addition, as the target area subtended by a projected pixel grows, vibration spatial mode averaging increases. Aliased DH imaging overcomes these limitations by combining sparse illumination to mitigate mode averaging and produce band limited signals, and then utilizing controlled aliasing to extend the DH field-of-view. The sparse nature of the illumination also creates a sparse signal for reconstruction.

Vibration mode averaging can be avoided by transmitting sparsely spaced narrow illumination spots distributed across the target as illustrated by the spots within the detector footprints within FIG. 6. These small transmitted spots provide spatial samples matched to the expected target and speckle size. This reduces the effective detector footprint to the size of the transmitted spot, and should encompass a single phase. If the number of samples remains the same, the spots become sparse on the target with un-illuminated areas between the illuminated spots.

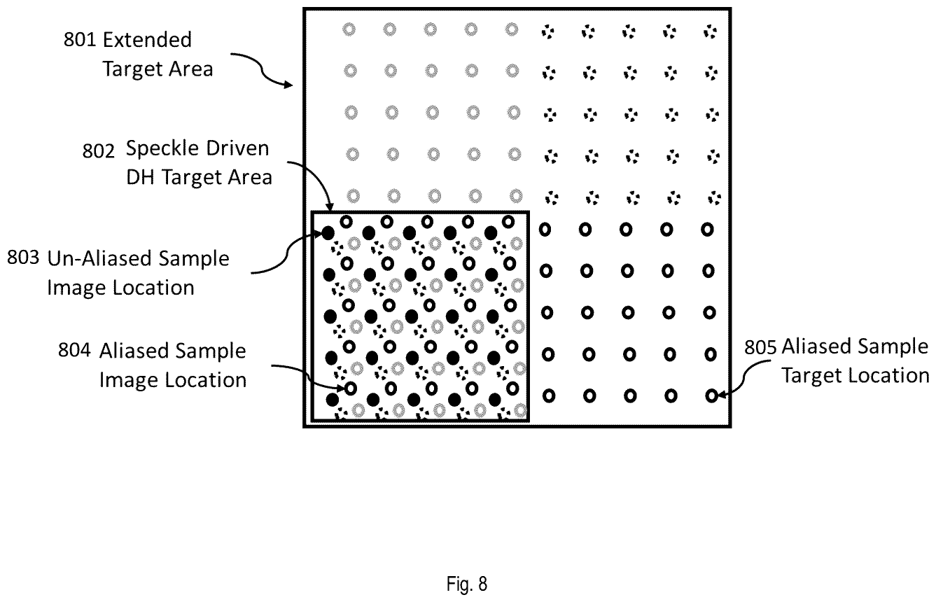

Since the illuminated target areas are now sparse, controlled aliasing of the bandlimited signals can be used to provide target measurements beyond the speckle spatial limited target size. FIG. 8 shows the speckle limited target image 802. The black circles are un-aliased sample locations 803 within that region. A single sided extended target region 801 includes sparsely illuminated samples where locations above the gray, dashed and black open circles denotes sparsely illuminated points 805 in the extended target region 801. As shown in the example points, the fringes due to each of these spots 805 is above the Nyquist limit and will be aliased into the image locations as shown 804. Since the signals are sparse, they do not interfere with each other and samples can simply be mapped back to their un-aliased positions after processing.

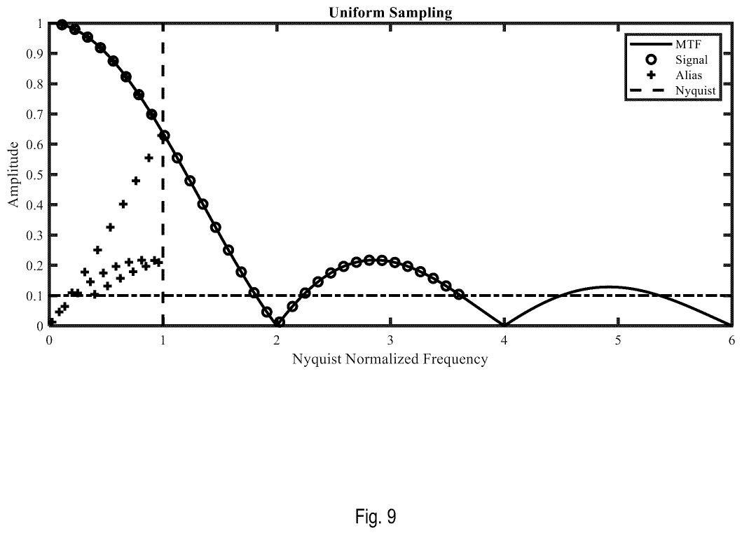

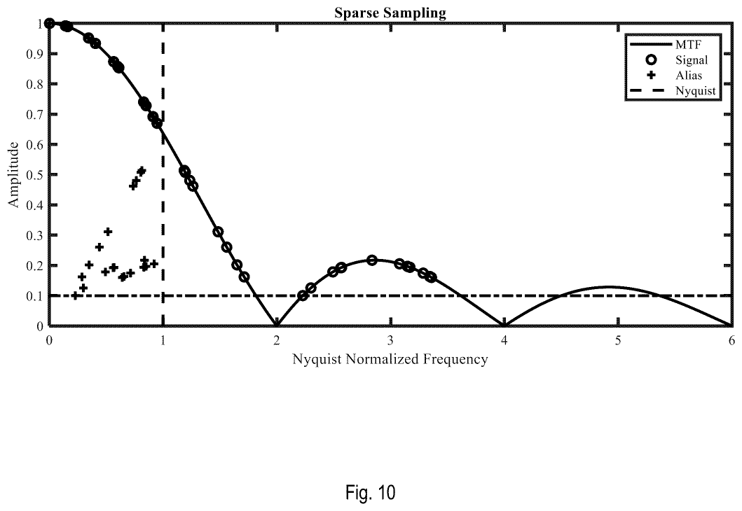

The spot spacings are chosen to fill target images space with non-overlapping aliased samples from the extended target field. The aliased frequency fₐ, is given as

$${f}_{a} = \vert 2 {mf}_{N} - {f}_{s} \vert \qquad ( 7 )$$

where f_{N} is the Nyquist frequency, fₛ is the signal frequency, and m is an integer such that fₐ<f_{N}. With Ideal sampling, e.g., a delta sampler, the aliased points can be placed anywhere. However, the detector MTF selectively modulates the aliased frequency. Referencing FIG. 9, a one dimensional uniformly distributed aliased sampling signal configuration (circles on the main plot line) and the location and MTF modulated amplitudes (pluses) within the aliased image space. This would have samples located near zeros in the which would highly suppress the measurements at those points. One method to improve performance would be to set an MTF threshold below which no energy would be transmitted to those points. Referencing FIG. 10, a one dimensional representation shows another embodiment that both avoids the MTF zeros, but also takes further advantage of the sparse nature of the illumination. Here, the illumination spots are randomly distributed across the extended target extend (circles) resulting in non-overalapped samples in the aliased space. This distribution allows sparse spatial reconstruction techniques to be employed where the maximum spatial frequency that can be recovered is associated with the precision of the sample location and not the pixel spacing. This allows measurement of both larger targets as well as enhanced resolution spatial reconstructions of the vibrating surface.

Referencing FIG. 9 and FIG. 10, the MTF will have significant impact on the measurement introducing a frequency, or spatially, a dependent contrast variance. To produce a spatially uniform measurement, the illumination spot array can be modulated with the inverse of the MTF amplitude. The amplitude modulated spot distribution could be generated with fixed special purpose grating or with active devices such as liquid crystal phase modulators.

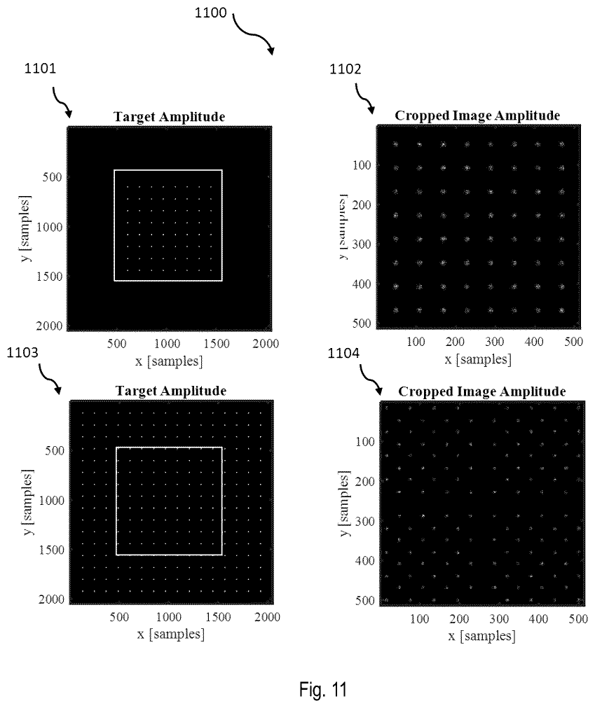

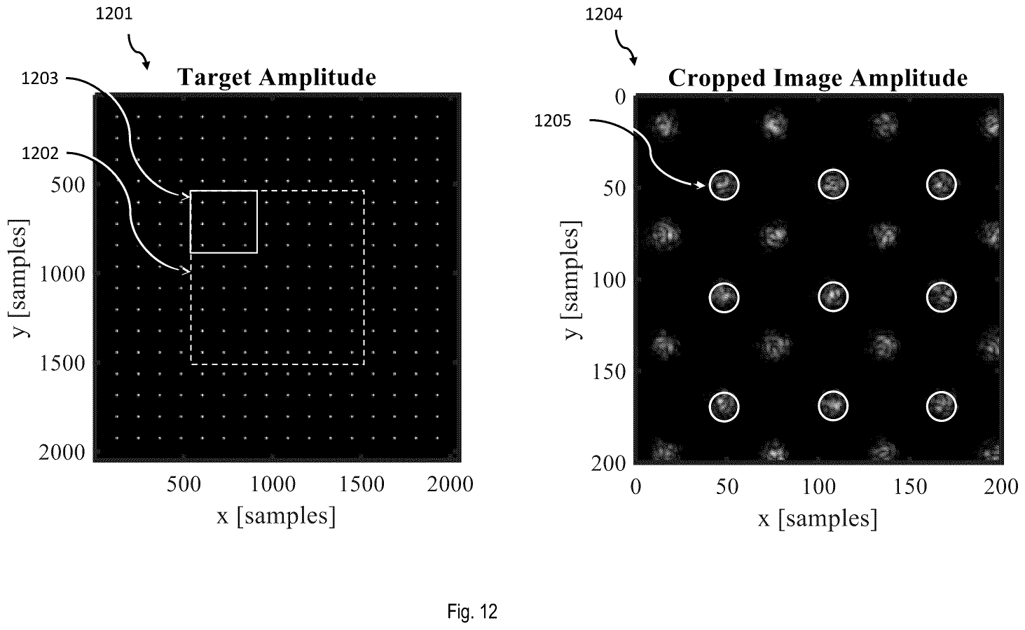

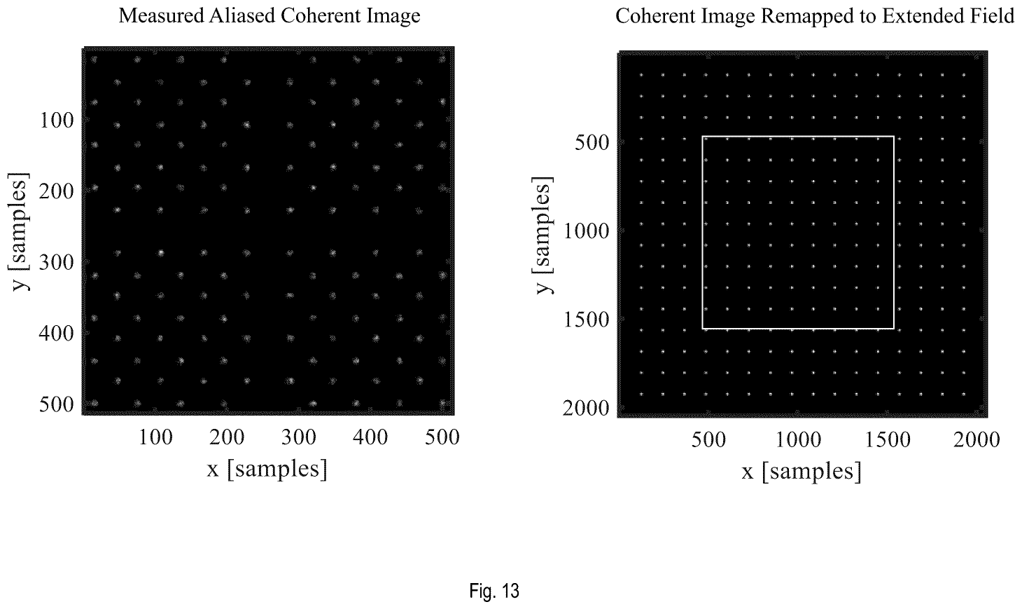

Referencing FIG. 11, an example of a normal uniform illumination 1101 and extended field illumination 1103 are shown, with a cropped image amplitude 1102, 1104 depicted next to each illumination depiction. The normal detected image 1102 correctly locates the transmit beams in the image whereas the extended field points are aliased and lie within the normal field of view. Referencing FIG. 12, the normal field 1203 and expanded region 1202 are shown within the extended field 1201 where the aliased sample points are folded into the normal field 1203. The expanded area 1204 is cropped and shows the un-aliased sample points 1205 interspersed but separated from the aliased sample points. Referencing FIG. 13, the aliased sample points 1301 can be remapped using the aliasing equations and placed in the appropriate location within the extend field image 1302. This constitutes the sparse measurement of a single complex image of the extended target field.

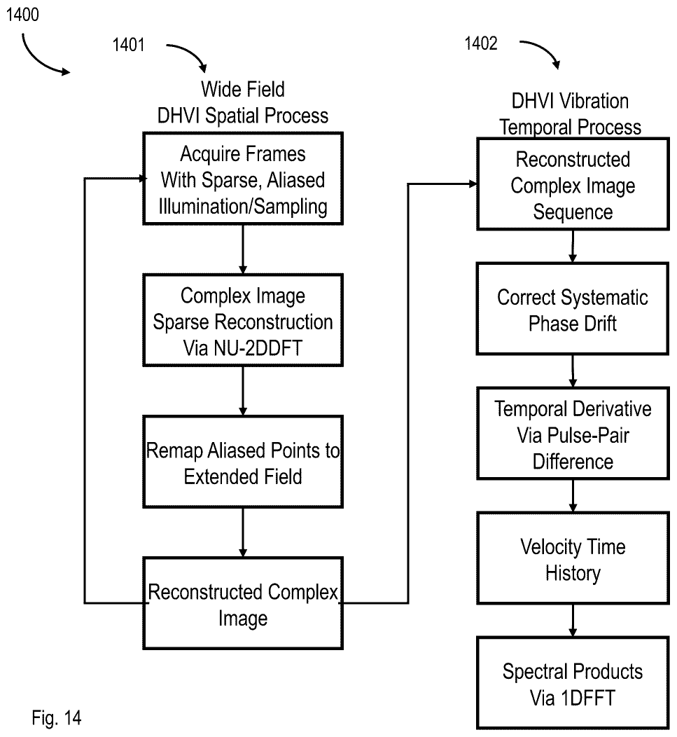

To measure the vibration, the spatially sparsely sampled holographic measurements are repeated over time to generate a sequence of complex images representing the spatially resolved temporal phase history data (PHD) 207 of the target 105. An example overall spatio-temporal process 1400 is summarized in FIG. 14. The example process 1400 includes an operation 1401 for wide field DHVI spatial processing, and an operation 1402 for DHVI temporal processing. Example operations for the DHVI spatial processing 1401 are set forth following.

The sparse sampling of the extended field creates a pupil with aliased frequency content. The complex image at time, S (x,y;tₙ), is calculated using for the non-uniform spatial sampling using the non-uniform discrete Fourier transform of type II (NUDFT-II) as

$$S ( {f}_{x k} , {f}_{y l} ) = {\sum }_{n = 0}^{N - 1} {\sum }_{m = 0}^{M - 1} {A}_{mn} {e}^{- j 2 π ( {x}_{n} {f}_{xk} + {y}_{m} {f}_{yl} )} \qquad ( 8 )$$

where A_{0,0} . . . , A_{N-1,M-1} are the complex values, x₀ . . . , x_{N-1} and y₀ . . . , y_{N-1} are the measurement locations, fₓ₁ . . . , f_{xK} and f_{y1} . . . , f_{yL} are the frequencies over which the transform is to be calculated. This creates the complex image where the aliased sample points from the extended field are intermixed with the un-aliased sample points 1301. Since the sparse illumination provides a sparse image, the aliased points are bandlimited and can be placed into the extended field according to the mapping

$${f}_{a} = \vert 2 {mf}_{N} - {f}_{s} \vert ⇔ \pm {f}_{a} = 2 m {f}_{N} - {f}_{s} \qquad ( 9 )$$

In this case, fₐ is positive and m is known for each aliased sample so the remapped signal frequency, fₛ is

$${f}_{s} = 2 m {f}_{N} - {f}_{a} \qquad ( 10 )$$

which results in the remapped extended field 1302. The image formation process is repeated over time to create a sequence of complex images containing the phase history of the target for each spatial sample. The sequence of images is corrected for systematic phase errors.

In the temporal process 1402, basic vibration processing is applied for the time record of each pixel. Pulse-pair, or doublet, processing was originally developed for radar Doppler processing, but was adapted for vibration sensing.

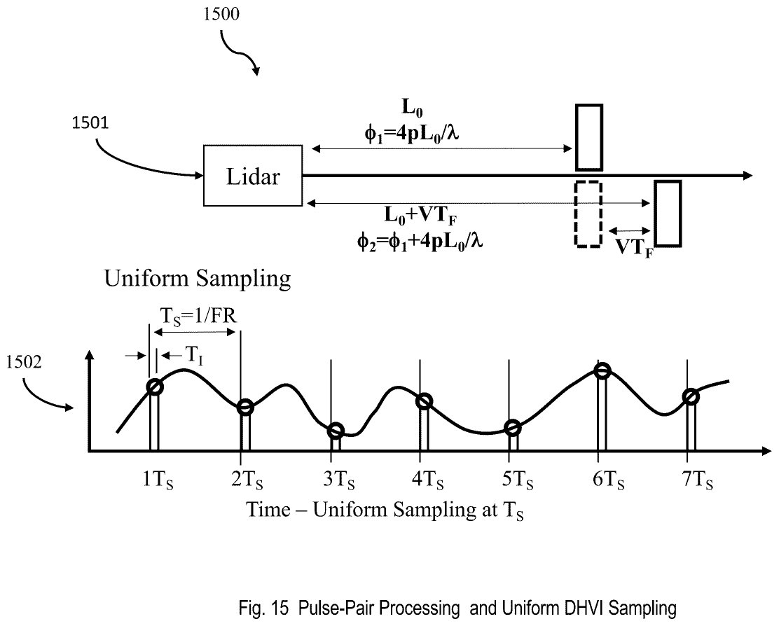

Referencing FIG. 15, the pulse-pair operation for a typical uniform temporal sampling system is shown where the measurement time is Tₛ=1/frame rate. For each frame in the complex data volume 301, the complex image, S (x,y;nT_{S}), is given

$$S ( x , y ; n {T}_{S} ) = A ( x , y ; n {T}_{s} ) {e}^{( j ϕ ( x , y ; {nT}_{s} ) )} \qquad ( 11 )$$

where the sampling interval is T_{S}=1/framerate, x and y are the spatial locations and A and ϕ are the amplitude and phase of each complex image location. The phase is the modulo-2π measurement of the range which is proportional to the current roundtrip range to the target, i.e., ϕₙ=4π(R)/4λ. for the next pulse the range has increased depending of the surface velocity and the phase is ϕₙ=4π(R+VTₛ)/4λ.

In pulse-pair processing, the velocity of each pixel, v(x,y,nTₛ), is found by taking derivative of the phase with respect to time for the sequence of complex images as

$$\begin{matrix}v ( x , y ; n {T}_{s} ) = \frac{1}{2 k n {T}_{s}} ∠ \{ S ( x , y ; n {T}_{s} ) S * ( x , y ; ( n + 1 ) {T}_{s} ) \} \\ = \begin{matrix}\frac{1}{2 k {T}_{s}} ∠ \{ A ( x , y ; {nT}_{s} ) {e}^{( j ϕ ( x , y ; {nT}_{s} ) )} \\ A ( x , y ; n + 1 ) {T}_{s} ) {e}^{( - j ϕ ( x , y ; {nT}_{s} ) )} \}\end{matrix} \\ = \frac{1}{2 k {T}_{s}} \{ ϕ ( x , y ; {nT}_{s} ) - ϕ ( x , y ; ( n + 1 ) {T}_{s} ) \}\end{matrix} \qquad ( 12 )$$

where k is the wave number of the laser and S, A and ϕ are the complex signal, amplitude and phase of each measured pulselet, respectively. For a given frame rate (FR), the sampling period, Tₛ=1/FR, is the time between the pulselets and determines the maximum temporal measurement bandwidth. The spatially resolved vibration spectra, V(x,y,ωₙ), is then calculated by taking the Fourier transform of the velocity time history with respect to time over each x, y pixel as

$$V ( x , y ; ω [ n ] ) = {\vert \frac{1}{2 {kT}_{s}} {FFT}_{t} \{ ϕ ( x , y ; ( n ) {T}_{s} ) - ϕ ( x , y ; ( n + 1 ) {T}_{s} ) \} \vert}^{1 / 2} \qquad ( 13 )$$

The data volume V (x,y;ωₙ) contains the target vibration spectrum for each spatial location across the measurement field. The target field extent was extended by controlled aliasing. An embodiment with uniform spatial sampling will provide Nyquist frequency support. An embodiment with non-uniform spatial sampling can provide increased spatial resolution for sparse targets. A wide variety of temporal processing approaches, including approaches with sparse temporal sampling and estimation (e.g., reference PCT application no. PCT/US2023/031993, entitled “SYSTEM, METHOD, AND APPARATUS FOR DIGITAL HOLOGRAPHIC VIBRATION IMAGING WITH INTEGRAL SPARSE PRECISION TEMPORAL SAMPLING”, filed on 5 Sep. 2023), can be applied in addition to the spatially sparse complex image described here. The PCT application no. PCT/US2023/031993, now published as WO 2024/054444, is incorporated herein by reference for all purposes.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

What is claimed is:

1. A vibration image measurement system comprising:
a stable laser light source configured to provide a master reference in a Doppler vibrometer scheme;
a camera configured to receive scattered light from an object and a reference beam;
an optical device configured to generate multiple illumination beams;
an acquisition system configured to acquire images and precision timing data returned from the object;
an image processor configured to demodulate light detected by the camera via digital holographic scheme;
an image processor configured to perform pulse-pair Doppler processing to determine vibration of the object;
first optics configured to direct light from the stable laser light source to provide sparse illumination of the object;
second optics configured to provide the reference beam for the camera;
relay optics configured to provide required image locations of the sparse illumination spots; and
third optics configured to mix the received light with the spatially offset reference beam for holographic detection.

2. The vibration measurement system of claim 1, further comprising fixed plates configured to create uniformly spaced sparse illumination spots in an extended target measurement field.

3. The vibration measurement system of claim 1, further comprising fixed plates configured to create randomly spaced sparse illumination spot in an extended target measurement field.

4. The vibration measurement system of claim 1, further comprising a programmable phase plate configured to create arbitrarily spaced sparse illumination spots in an extended target measurement field.

5. The vibration measurement system of claim 1, further comprising wherein an amplitude of transmitted spots is modulated to provide uniform detection across an extended target measurement field.

6. The vibration measurement system of claim 1, wherein the image processor is further configured to create complex images containing the amplitude and phase for each image location utilizing digital holographic detection and demodulation.

7. The vibration measurement system of claim 6, wherein the image process is further configured to create the complex images for each image location from an extended target field.

8. The vibration measurement system of claim 1, wherein the image processor is further configured to create complex images for each image location from an extended target field utilizing digital holographic detection and demodulation.

9. The vibration measurement system of claim 1, wherein the image processor is further configured to create complex images containing the amplitude and phase for each image location from an extended target field utilizing digital holographic detection and demodulation, and aliased bandlimited signals.

10. The vibration measurement system of claim 1, wherein the image processor is further configured to create complex images containing the amplitude and phase for each image location from an extended target field utilizing digital holographic detection and demodulation, and sparse aliased bandlimited signals to create high spatial resolution complex images.

11. The vibration measurement system of claim 1, wherein the image processor is further configured to develop spectral products at a maximum frame rate utilizing temporal pulse-pair Doppler processing with uniform temporal sampling.

12. The vibration measurement system of claim 1, wherein the image processor is further configured to develop spectral products utilizing combined spatial and temporal sparse processing.

13. The vibration measurement system of claim 1, wherein the image processor is further configured to apply sparse temporal pulse-pair processing having a temporal precision equal to a temporal integration time.

14. The vibration measurement system of claim 13, wherein the image processor is further configured to apply the sparse temporal pulse-pair processing at a maximum frame rate.

15. The vibration measurement system of claim 1, wherein the image processor is further configured to perform holographic imaging to extract a complex image with amplitude and phase.

16. The vibration measurement system of claim 1, wherein the image processor is further configured to perform sparse digital holographic image formation of extended target fields from aliased, bandlimited randomly spaced samples.

17. The vibration measurement system of claim 1, wherein the image processor is further configured to perform sparse digital holographic image formation of extended target fields from aliased, bandlimited uniformly spaced samples.

18. The vibration measurement system of claim 1, wherein the image processor is further configured to perform sparse pulse-pair Doppler processing to extract a phase signal from each location within a complex data volume.

19. The vibration measurement system of claim 1, wherein the holographic detection is performed in an image plane of the camera.

20. The vibration measurement system of claim 1, wherein at least one of the optical device or the stable laser light source comprises an amplified illumination laser.

21. The vibration measurement system of claim 1, wherein the image processor is further configured to measure and correct systematic phase perturbations.

22. The vibration measurement system of claim 1, wherein at least one of the optical device or the stable laser light source comprises a pulsed illumination laser.

23. The vibration measurement system of claim 1, wherein the camera is further configured to provide precision timing holographic detection in an image plane of the camera.
